(19) United States
(12) Patent Application Publication
(10) Pub. No.: US 2025/0368763 A1
(43) Pub. Date: Dec. 4, 2025

(54) VINYL ESTER/ (METH)ACRYLATE POLYMER DISPERSION

(71) Applicant: Synthomer (UK) Limited, Harlow, Essex (GB)

(72) Inventors: Christopher DAVIS, Harlow, Essex (GB); Cedric LEROYER, Harlow, Essex (GB)

(73) Assignee: Synthomer (UK) Limited, Harlow, Essex (GB)

(21) Appl. No.: 18/869,892

(22) PCT Filed: May 11, 2023
(86) PCT No.: PCT/EP2023/062536

§ 371 Date: Nov. 27, 2024

(30) Foreign Application Priority Data
May 31, 2022 (EP) 22176526.6

(51) Int. Cl. C08F 18/08

(52) U.S. Cl. CPC C08F 18/08

(57) ABSTRACT

The present invention relates to a method for producing a polymer dispersion and to an aqueous polymer dispersion obtained by such method as well as to the use of the aqueous polymer dispersion. Furthermore, in particular but not exclusively, the present invention is directed to a redispersible polymer powder and the use of the redispersible polymer powder as well as to building materials comprising such aqueous polymer dispersion or redispersible polymer powder.

The present invention relates to a method for producing a polymer dispersion and to an aqueous polymer dispersion obtained by such method as well as to the use of the aqueous polymer dispersion. Furthermore, in particular but not exclusively, the present invention is directed to a redispersible polymer powder and the use of the redispersible polymer powder as well as to building materials comprising such aqueous polymer dispersion or redispersible polymer powder.

### BACKGROUND OF THE INVENTION

Aqueous polymer dispersions and corresponding redispersible powders have for many years been indispensable additives for applications in the construction sector, for example for renders, mortars, reinforcement compositions, self-leveling compositions, tile adhesives, paints and composite thermal insulation systems. Especially for high-quality renders, there is constantly increasing use of binders which give properties such as better mechanical properties, better weathering resistance and lower susceptibility to soiling.

Preference has hitherto been given to protective colloid stabilized polymerizations using vinyl ester monomers and (meth)acrylate monomers for preparing these polymer dispersions. However, plasticizers and coalescing agents are usually necessary to maintain film flexibility. These plasticizers and coalescing agents are undesirable as they may contribute to the volatile organic compounds content (VOC) of the product. As the plasticizers and coalescing agents are not permanently bonded to the polymer structure, migration of these plasticizers and coalescing agents may occur.

Furthermore, polymerization of different vinyl ester monomers as well as (meth)acrylate monomers for the production of polymer dispersions, which can be dried to form a redispersible powder is difficult due to different reactivity ratios between the monomers and due to different rates of grafting reactions of the monomers with the protective colloids. This can result in deteriorated stabilization of the polymer dispersion and in reduced polymer performance.

EP 1 262 465 A2 relates to the use of copolymers which are derived from vinyl ester, (meth)acrylic ester and optionally ethylene comonomers and are stabilized with protective colloid, in the form of their aqueous dispersions or redispersible polymer powders, and their use in building materials.

It has surprisingly been found that the process of the present invention allows for the formation of polymer dispersions having low glass transition temperatures, which provides film flexibility and film formation at low temperatures, while having enhanced chemical resistance. Moreover, the process of the present invention allows for the formation of polymer dispersions having high resistance to degradation in water, without impairing the re-wetting. The process further allows for the formation of polymer dispersions having a low VOC content. The present method further provides the formation of polymer dispersions with a broad range of compositions, which allows tailoring of the polymer dispersion properties to suit a wide range of possible applications.

### SUMMARY OF THE INVENTION

The following clauses summarize some aspects of the present invention.

According to a first aspect, the present invention relates to a method for producing a polymer dispersion by free-radical emulsion or suspension polymerization of a mixture of ethylenically unsaturated monomers comprising the steps of:
(i) providing an aqueous composition comprising a first mixture of ethylenically unsaturated monomers comprising:
   (a) a vinyl ester of an alkanoic acid of the structural formula

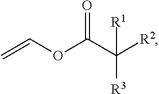

wherein R¹ is H or CH₃; and R² and R³ are alkyl groups which collectively contain 6 to 8 carbon atoms; and
(b) a vinyl ester of an alkanoic acid different than the vinyl ester of an alkanoic acid (a);
and polymerizing the mixture of ethylenically unsaturated monomers in the presence of protective colloids to obtain seed particles;
(ii) adding a second mixture of ethylenically unsaturated monomers comprising:
(a) a vinyl ester of an alkanoic acid of the structural formula

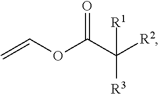

wherein R¹ is H or CH₃; and R² and R³ are alkyl groups which collectively contain 6 to 8 carbon atoms; and
(b) a vinyl ester of an alkanoic acid different than the vinyl ester of an alkanoic acid (a);
to the aqueous composition after step (i);
and polymerizing the mixture of ethylenically unsaturated monomers in the presence of protective colloids;
(iii) adding a third mixture of ethylenically unsaturated monomers comprising:
   (a) a vinyl ester of an alkanoic acid of the structural formula

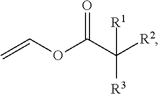

wherein R¹ is H or CH₃; and R² and R³ are alkyl groups which collectively contain 6 to 8 carbon atoms; and
(b) a (meth)acrylate;
to the aqueous composition after step (ii);
and polymerizing the mixture of ethylenically unsaturated monomers;
(iv) adding a fourth mixture of ethylenically unsaturated monomers comprising a vinyl ester of an alkanoic acid to the aqueous composition after step (iii); and polymerizing the mixture of ethylenically unsaturated monomers.

The vinyl ester of an alkanoic acid (a) in one of, more than one of, or all, preferably all of the first to third mixtures of ethylenically unsaturated monomers may have the structural formula of

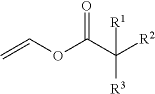

wherein R¹ is H or CH₃; and R² and R³ are alkyl groups which collectively contain 6 or 7 carbon atoms.

The vinyl ester of an alkanoic acid (a) in one of, more than one of, or all, preferably all of the first to third mixtures of ethylenically unsaturated monomers may have the structural formula of

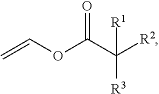

wherein R¹ is CH₃; and R² and R³ are alkyl groups which collectively contain 7 carbon atoms.

The vinyl ester of an alkanoic acid (a) in one of, more than one of, or all, preferably all of the first to third mixtures of ethylenically unsaturated monomers may have the structural formula of

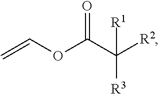

wherein R¹ is H; and R² and R³ are alkyl groups which collectively contain 6 carbon atoms.

The vinyl ester of an alkanoic acid (b) different than the vinyl ester of an alkanoic acid (a) in one of, more than one of, or all, preferably all of the first to third mixtures of ethylenically unsaturated monomers may comprise vinyl acetate, 1-methylvinyl acetate, vinyl propionate, vinyl butyrate, vinyl laurate, vinyl pivalate, and combinations thereof, preferably vinyl acetate.

The vinyl ester of an alkanoic acid of the fourth mixture of ethylenically unsaturated monomers may comprise vinyl acetate, 1-methylvinyl acetate, vinyl propionate, vinyl butyrate, vinyl laurate, vinyl pivalate, and combinations thereof, preferably vinyl acetate.

The first mixture of ethylenically unsaturated monomers may comprise:
(a) 10 to 90 wt.-%, preferably 20 to 80 wt.-%, more preferably 20 to 70 wt.-% of the vinyl ester of an alkanoic acid; and
(b) 10 to 90 wt.-%, preferably 20 to 80 wt.-%, more preferably 30 to 80 wt.-% of the vinyl ester of an alkanoic acid different than the vinyl ester of an alkanoic acid (a); the weight percentages being based on the total weight of the monomers in the first mixture of ethylenically unsaturated monomers.

The second mixture of ethylenically unsaturated monomers may comprise:
(a) 10 to 70 wt.-%, preferably 15 to 60 wt.-%, more preferably 20 to 50 wt.-% of the vinyl ester of an alkanoic acid; and
(b) 30 to 90 wt.-%, preferably 40 to 85 wt.-%, more preferably 50 to 80 wt.-% of the vinyl ester of an alkanoic acid different than the vinyl ester of an alkanoic acid (a); and the weight percentages being based on the total weight of the monomers in the second mixture of ethylenically unsaturated monomers.

The third mixture of ethylenically unsaturated monomers may comprise:
(a) 10 to 70 wt.-%, preferably 15 to 60 wt.-%, more preferably 30 to 50 wt.-% of the vinyl ester of an alkanoic acid; and
(b) 35 to 90 wt.-%, preferably 40 to 85 wt.-%, more preferably 50 to 80 wt.-% of the (meth)acrylate; the weight percentages being based on the total weight of the monomers in the third mixture of ethylenically unsaturated monomers.

The (meth)acrylate may be selected from methyl (meth)acrylate, ethyl (meth)acrylate, propyl (meth)acrylate, isopropyl (meth)acrylate, butyl (meth)acrylate, isobutyl (meth)acrylate, tert-butyl (meth)acrylate, hexyl (meth)acrylate, 2-ethylhexyl (meth)acrylate, heptyl (meth)acrylate, isooctyl (meth)acrylate, nonyl (meth)acrylate, 4-methyl-2-pentyl (meth)acrylate, 2-methylbutyl (meth)acrylate, 3,5,5-trimethylhexyl (meth)acrylate, and combinations thereof, preferably butyl (meth)acrylate and combinations thereof.

The seed particles in step (i) may have a median particle size in the range of 100 to 300 nm.

The protective colloid of the first step (i) and/or second step (ii), preferably of the first step (i) and second step (ii), may comprise polyvinyl alcohol, polyvinyl alcohol copolymers and combinations thereof, preferably polyvinyl alcohol.

The polyvinyl alcohol may have a degree of hydrolysis in a range of from 80 to 99 mol.-%, preferably from 80 to 95 mol.-%, more preferably from 85 to 94 mol.-%; and a viscosity in a range of from 1 to 56 mPa·s, preferably 2 to 50 mPa·s, more preferably from 3 to 40 mPa·s as determined by a Höppler falling ball viscometer following DIN 53015:2019 for a 4 wt.-% aqueous solution of the polyvinyl alcohol at 20° C.

The protective colloid may be added in the first step (i) in an amount in a range of 2.0 to 11.0 wt.-%, the weight percentages being based on the total weight of the monomers in the first to fourth mixtures of ethylenically unsaturated monomers.

The first mixture of ethylenically unsaturated monomers may further comprise a chain transfer agent, wherein the chain transfer agent preferably is selected from n-dodecyl mercaptan, carbon tetrachloride, carbon tetrabromide, bromotrichloro methane, 4-methylbenzenethiol, isooctyl 3-mercaptopropionate, tert-nonyl mercaptan, 4,4′-thiobisbenzenethiol, tert-dodecyl mercaptan, alpha-methyl styrene dimer, thioglycolic acid, 2-ethylhexyl thioglycolate, butyl 3-mercaptopropionate, 1,8-dimercapto-3,6-dioxa octane and combinations thereof.

In step (ii), the second mixture of ethylenically unsaturated monomers may be added continuously so that the reaction temperature is in the range of from 70 to 90° C.

Step (iii) may be started when no new seed particles are formed in step (ii).

In step (iii), the third mixture of ethylenically unsaturated monomers may be added continuously so that the reaction temperature is in the range of from 70 to 90° C.

The first mixture of ethylenically unsaturated monomers (i) may comprise 1 to 15 wt.-% of the ethylenically unsaturated monomers;

the second mixture of ethylenically unsaturated monomers (ii) may comprise 35 to 90 wt.-% of the ethylenically unsaturated monomers;

the third mixture of ethylenically unsaturated monomers (iii) may comprise 8 to 50 wt.-% of the ethylenically unsaturated monomers; and

the fourth mixture of ethylenically unsaturated monomers (iv) may comprise 1 to 20 wt.-% of the ethylenically unsaturated monomers;

the weight percentages being based on the total weight of the ethylenically unsaturated monomers of the first to fourth mixtures of ethylenically unsaturated monomers.

The mixture of ethylenically unsaturated monomers may be polymerized by free-radical emulsion polymerization.

According to a further aspect of the present invention, the invention is directed to an aqueous polymer dispersion obtained by the method as discussed above.

In addition, a further aspect of the present invention relates to a redispersible polymer powder obtained by drying the aqueous polymer dispersion as discussed above.

The drying may be achieved by fluidized-bed drying, freeze drying or spray drying.

Another aspect of the present invention relates to use of the aqueous polymer dispersion as discussed above or the redispersible polymer powder as discussed above in building materials such as building adhesives, plasters, fillers, floor fillers, sealing slurries, grouts and paints.

A further aspect of the present invention relates to a building material comprising the aqueous polymer dispersion as discussed above or the redispersible polymer powder as discussed above.

The building material may be selected from cementitious tile adhesives; self-leveling substrates; thermal insulation systems (ETICS); repair mortars; cementitious grouts; joint fillers; plaster and gypsum; jointing compounds; fillers; or waterproofing compounds.

### DETAILED DESCRIPTION OF THE INVENTION

The present invention relates to a method for producing a polymer dispersion by free-radical emulsion or suspension polymerization of a mixture of ethylenically unsaturated monomers. The method of the invention comprises the steps of: (i) providing an aqueous composition comprising a first mixture of ethylenically unsaturated monomers, and polymerizing the mixture of ethylenically unsaturated monomers in the presence of protective colloids to obtain seed particles; (ii) adding a second mixture of ethylenically unsaturated monomers to the aqueous composition after step (i); and polymerizing the mixture of ethylenically unsaturated monomers in the presence of protective colloids; (iii) adding a third mixture of ethylenically unsaturated monomers to the aqueous composition after step (ii); and polymerizing the mixture of ethylenically unsaturated monomers; and (iv) adding a fourth mixture of ethylenically unsaturated monomers, and polymerizing the mixture of ethylenically unsaturated monomers.

As used herein, the term “aqueous” refers to a medium that either consists exclusively of water or comprises predominantly water (e.g., at least 50 wt.-% water) in combination with a non-aqueous solvent. Non-aqueous solvents may be employed in the aqueous composition of the invention in small amount if desired.

The amount of non-aqueous solvents may be 3 wt.-% or less, preferably 2 wt.-% or less, more preferably 1.5 wt.-% or less, most preferably 1 wt.-% or less, and in particular 0.5 wt. or less based on the total weight of water and the non-aqueous solvents. Examples of suitable non-aqueous solvents include, but are not limited to, toluene, acetone, methylethylketone, cyclohexane, ethylene glycol dimethyl ether, ethylene glycol diethyl ether, ethylene glycol methyl ether, diethylene glycol dimethyl ether, diethylene glycol diethyl ether, diethylene glycol methyl ether, dimethylformamide, dimethyl sulfoxide, monohydric alcohols such as methanol and ethanol, and polyhydric alcohols. The aqueous composition is preferably free of non-aqueous solvents.

The first mixture of ethylenically unsaturated monomers (i) comprises: (a) a vinyl ester of an alkanoic acid of the structural formula

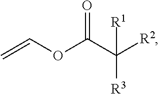

wherein R¹ is H or CH₃; and R² and R³ are alkyl groups which collectively contain 6 to 8 carbon atoms, preferably 6 or 7 carbon atoms; and (b) a vinyl ester of an alkanoic acid different than the vinyl ester of an alkanoic acid (a).

The vinyl ester of an alkanoic acid (a) of the first mixture of ethylenically unsaturated monomers (i) may have the structural formula of

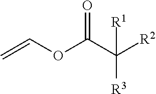

wherein R¹ is CH₃; and R² and R³ are alkyl groups which collectively contain 7 carbon atoms.

The vinyl ester of an alkanoic acid (a) of the first mixture of ethylenically unsaturated monomers (i) may have the structural formula of

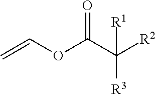

wherein R¹ is H; and R² and R³ are alkyl groups which collectively contain 6 carbon atoms, wherein preferably R² is an ethyl group and R³ is a butyl group.

Suitable examples of a vinyl ester of an alkanoic acid (a) of the first mixture of ethylenically unsaturated monomers (i) that can be used according to the present invention can be exemplified by VeoVa grade vinyl esters commercially available from Hexion Inc. (USA), such as VeoVa 9 vinyl ester, VeoVa 10 vinyl ester, and Veova EH vinyl ester.

According to the present invention, the first mixture of ethylenically unsaturated monomers (i) may comprise at least 10 wt.-%, such as at least 13 wt.-%, or at least 15 wt.-%, or at least 18 wt.-%, or at least 20 wt.-%, or at least 23 wt.-%, or at least 25 wt.-% of the vinyl ester of an alkanoic acid (a). The first mixture of ethylenically unsaturated monomers (i) may comprise 90 wt.-% or less, such as 85 wt.-% or less, or 80 wt.-% or less, or 75 wt.-% or less, or 70 wt.-% or less, or 65 wt.-% or less of the vinyl ester of an alkanoic acid (a). A person skilled in the art will appreciate that any range between any of the explicitly disclosed lower and upper limit is herein disclosed. Accordingly, the first mixture of ethylenically unsaturated monomers (i) may comprise 10 to 90 wt.-%, preferably 20 to 80 wt.-%, more preferably 20 to 70 wt.-% of the vinyl ester of an alkanoic acid (a). The weight percentages are based on the total weight of the monomers in the first mixture of ethylenically unsaturated monomers.

The vinyl ester of an alkanoic acid (b) different than the vinyl ester of an alkanoic acid (a) in the first mixture of ethylenically unsaturated monomers (i) may comprise vinyl acetate, 1-methylvinyl acetate, vinyl propionate, vinyl butyrate, vinyl laurate, vinyl pivalate, and combinations thereof. Preferably, the vinyl ester of an alkanoic acid (b) comprises vinyl acetate.

According to the present invention, the first mixture of ethylenically unsaturated monomers (i) may comprise at least 10 wt.-%, such as at least 13 wt.-%, or at least 15 wt.-%, or at least 18 wt.-%, or at least 20 wt.-%, or at least 23 wt.-%, or at least 25 wt.-%, or at least 30 wt.-%, or at least 35 wt.-% of the vinyl ester of an alkanoic acid (b) different than the vinyl ester of an alkanoic acid (a). The first mixture of ethylenically unsaturated monomers (i) may comprise 90 wt.-% or less, such as 88 wt.-% or less, or 85 wt.-% or less, or 83 wt.-% or less, or 80 wt.-% or less, or 78 wt.-% or less, or 75 wt.-% or less of the vinyl ester of an alkanoic acid (b) different than the vinyl ester of an alkanoic acid (a). A person skilled in the art will appreciate that any range between any of the explicitly disclosed lower and upper limit is herein disclosed. Accordingly, the first mixture of ethylenically unsaturated monomers (i) may comprise 10 to 90 wt.-%, preferably 20 to 80 wt.-%, more preferably 30 to 80 wt.-% of the vinyl ester of an alkanoic acid (b) different than the vinyl ester of an alkanoic acid (a). The weight percentages are based on the total weight of the monomers in the first mixture of ethylenically unsaturated monomers.

According to the present invention, the first mixture of ethylenically unsaturated monomers (i) may comprise 10 to 90 wt.-%, preferably 20 to 80 wt.-%, more preferably 20 to 70 wt.-% of the vinyl ester of an alkanoic acid (a); and 10 to 90 wt.-%, preferably 20 to 80 wt.-%, more preferably 30 to 80 wt.-% of the vinyl ester of an alkanoic acid (b) different than the vinyl ester of an alkanoic acid (a).

The weight percentages are based on the total weight of the monomers in the first mixture of ethylenically unsaturated monomers.

According to the present invention, the first mixture of ethylenically unsaturated monomers is polymerized in the presence of protective colloids. As used herein, the term “protective colloids” refers generally to water-soluble polymer compounds which are employed for stabilizing finely dispersed polymer particles. The protective colloids usually become attached to the particle by grafting during polymerization and can surround the particles with a film, and due to its, e.g., spatial expansion, may prevent the particles from approaching each other and thus from flocculating or coagulating. The protective colloid of the first step (i) may comprise polyvinyl alcohol, polyvinyl alcohol copolymers and combinations thereof. Preferably, the protective colloid may comprise polyvinyl alcohol. As used herein, the term “polyvinyl alcohol” is generally acknowledged in the art as a completely or partially hydrolyzed polyvinyl acetate. Suitable polyvinyl alcohol copolymers may comprise hydrophobic copolymers of polyvinyl alcohol with isopropenyl acetate, vinyl pivalate, vinyl ethylhexanoate, vinyl esters of saturated alpha-branched monocarboxylic acids having 5 or from 9 to 11 carbon atoms, dialkyl maleates, dialkyl fumarates, vinyl chloride, vinyl alkyl ethers, such as vinyl butyl ether, olefines, such as ethene and decene, and combinations thereof. The proportion of the hydrophobic units is preferably from 0.1 to 10 wt.-%, based on the total weight of the polyvinyl alcohol.

The polyvinyl alcohol may have a degree of hydrolysis of at least 80 mol.-%, such as at least 82 mol.-%, or at least 80 mol.-%. According to the present invention, the polyvinyl alcohol may have a degree of hydrolysis of 99 mol.-% or less, such as 98 mol.-% or less, or 97 mol.-% or less, or 96 mol.-% or less, or 95 mol.-% or less, or 94 mol.-% or less, or 93 mol.-% or less. A person skilled in the art will appreciate that any range between any of the explicitly disclosed lower and upper limit is herein disclosed. Accordingly, the polyvinyl alcohol may have a degree of hydrolysis in a range of from 80 to 99 mol.-%, preferably from 80 to 95 mol.-%, more preferably from 85 to 94 mol.-%. The degree of hydrolysis has to be understood as an average value meaning that mixtures of less hydrolyzed and more hydrolyzed polyvinyl alcohols can be used.

According to the present invention, the polyvinyl alcohol may have a viscosity of at least 1 mPa·s, such as at least 2 mPa·s, or at least 3 mPa·s. The polyvinyl alcohol of the present invention may have a viscosity of 56 mPa·s or less, such as 50 mPa·s or less, or 45 mPa·s or less, or 40 mPa·s or less, or 35 mPa·s or less, or 30 mPa·s or less. The viscosity may be determined by a Höppler falling ball viscometer following DIN 53015:2019 for a 4 wt.-% aqueous solution of the polyvinyl alcohol at 20° C. A person skilled in the art will appreciate that any range between any of the explicitly disclosed lower and upper limit is herein disclosed. Accordingly, the polyvinyl alcohol may have a viscosity in a range of from 1 to 56 mPa·s, preferably 2 to 50 mPa·s, more preferably from 3 to 40 mPa·s.

The polyvinyl alcohol of the present invention may have a degree of hydrolysis in a range of from 80 to 99 mol.-%, preferably from 80 to 95 mol.-%, more preferably from 85 to 94 mol.-%; and a viscosity in a range of from 1 to 56 mPa·s, preferably 2 to 50 mPa·s, more preferably from 3 to 40 mPa·s as determined by a Höppler falling ball viscometer following DIN 53015:2019 for a 4 wt.-% aqueous solution of the polyvinyl alcohol at 20° C.

Suitable examples of polyvinyl alcohols include, but are not limited to, Poval grade polyvinyl alcohols, and Exceval grade polyvinyl alcohols, both commercially available from Kuraray (Japan) as well as Mowiol grade polyvinyl alcohols commercially available from Clariant GmbH (Germany).

The aqueous composition may comprise at least 1.5 wt.-%, such as at least 1.8 wt.-%, or at least 2.0 wt.-%, or at least 2.2 wt.-%, or at least 2.5 wt.-% of the protective colloid. The aqueous composition may comprise 13.0 wt.-% or less, such as 12.5 wt.-% or less, or 12.0 wt.-% or less, or 11.5 wt.-% or less, or 11.0 wt.-% or less, or 10.5 wt.-% or less, or 10.0 wt.-% or less of the protective colloid. A person skilled in the art will appreciate that any range between any of the explicitly disclosed lower and upper limit is herein disclosed. Accordingly, the aqueous composition may comprise 1.5 to 11.0 wt.-%, preferably 2.0 to 11.0 wt.-% of the protective colloid. The weight percentages being based on the total weight of the monomers in the first to fourth mixtures of ethylenically unsaturated monomers. The protective colloids may be dissolved in the aqueous composition at elevated temperature, such as at temperatures in the range of 65 to 90° C., preferably 70 to 90° C.

The aqueous composition may comprise at least 1.5 wt.-%, such as at least 1.8 wt.-%, or at least 2.0 wt.-%, or at least 2.2 wt.-%, or at least 2.5 wt.-% of polyvinyl alcohol. The aqueous composition may comprise 13.0 wt.-% or less, such as 12.5 wt.-% or less, or 12.0 wt.-% or less, or 11.5 wt.-% or less, or 11.0 wt.-% or less, or 10.5 wt.-% or less, or 10.0 wt.-% or less of polyvinyl alcohol. A person skilled in the art will appreciate that any range between any of the explicitly disclosed lower and upper limit is herein disclosed. Accordingly, the aqueous composition may comprise 1.5 to 11.0 wt.-%, preferably 2.0 to 11.0 wt.-% of polyvinyl alcohol. The weight percentages being based on the total weight of the monomers in the first to fourth mixtures of ethylenically unsaturated monomers.

The protective colloid can all be charged initially or part of it can be charged initially and the remainder metered in in the aqueous composition. Preferably, the protective colloid may be charged all initially in the aqueous composition in step (i), and preferably before the first mixture of ethylenically unsaturated monomers is charged. The protective colloid may be added in the first step (i) in an amount in a range of 1.5 to 11.0 wt.-%, preferably 2.0 to 11.0 wt.-%, the weight percentages being based on the total weight of the monomers in the first to fourth mixtures of ethylenically unsaturated monomers. During step (i) of the method of the present invention, the ethylenically unsaturated monomers of the first monomer mixture can graft onto the protective colloids forming seed particles. The seed particles obtained in step (i) may have a median particle size of at least 50 nm, such as at least 60 nm, or at least 70 nm, or at least 80 nm, or at least 90 nm, or at least 100 nm. According to the present invention, the seed particles obtained in step (i) may have a median particles size of 350 nm or less, such as 330 nm or less, or 300 nm or less, or 280 nm or less. A person skilled in the art will appreciate that any range between any of the explicitly disclosed lower and upper limit is herein disclosed. Accordingly, seed particles obtained in step (i) may have a median particle size in the range of from 50 nm to 300 nm, preferably from 100 nm to 300 nm. The median particle size can be determined by dynamic light scattering according to ISO 22412:2017, e.g., with the dynamic light scattering instrument Mastersizer 2000 (Malvern Panalytical (United Kingdom)).

The first mixture of ethylenically unsaturated monomers may further comprise a chain transfer agent. According to the present invention, the chain transfer agent may be selected from n-dodecyl mercaptan, carbon tetrachloride, carbon tetrabromide, bromotrichloro methane, 4-methylbenzenethiol, isooctyl 3-mercaptopropionate, tert-nonyl mercaptan, 4,4′-thiobisbenzenethiol, tert-dodecyl mercaptan, alpha-methyl styrene dimer, thioglycolic acid, 2-ethylhexyl thioglycolate, butyl 3-mercaptopropionate, 1,8-dimercapto-3,6-dioxa octane and combinations thereof. If chain transfer agents are used, the chain transfer agents may be employed in amounts of at least 0.01 wt.-%, such as at least 0.03 wt.-%, or at least 0.05 wt.-%, or at least 0.07 wt.-%, or at least 0.10 wt.-%, or at least 0.12 wt.-%, or at least 0.15 wt.-%. If chain transfer agents are used, the chain transfer agents may be employed in amounts of 3.0 wt.-% or less, such as 2.8 wt.-% or less, or 2.5 wt.-% or less, or 2.3 wt.-% or less, or 2.0 wt.-% or less, or 1.8 wt.-% or less, or 1.5 wt.-% or less. A person skilled in the art will appreciate that any range between any of the explicitly disclosed lower and upper limit is herein disclosed. If chain transfer agents are used, the chain transfer agents may be employed in amounts of from 0.01 to 3.0 wt.-%, 0.05 to 2.0 wt.-%. The weight percentages being based on the total weight of the ethylenically unsaturated monomers of all mixtures of ethylenically unsaturated monomers.

Polymerizing the mixture of ethylenically unsaturated monomers in step (i) of the method of the present invention may be carried out as a batch polymerization or a semi-continuous polymerization. As used herein, the term “batch polymerization” refers to a polymerization, in which all the monomers, are added at the beginning of the polymerization reaction. The term “semi-continuous polymerization” refers to a polymerization, in which the monomers are added continuously. Preferably, polymerizing the mixture of ethylenically unsaturated monomers in step (i) of the method of the present invention is carried out as a batch polymerization. Typically, the polymerization in step (i) is an exothermic reaction, i.e., the reaction releases heat. The polymerization temperature in step (i) may be in a range of from 65 to 90° C., preferably 70 to 90° C.

The second mixture of ethylenically unsaturated monomers (ii) comprises: (a) a vinyl ester of an alkanoic acid of the structural formula

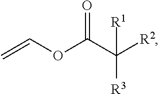

wherein R¹ is H or CH₃; and R² and R³ are alkyl groups which collectively contain 6 to 8 carbon atoms, preferably 6 or 7 carbon atoms; and (b) a vinyl ester of an alkanoic acid different than the vinyl ester of an alkanoic acid (a).

The second mixture of ethylenically unsaturated monomers (ii) may be added to the aqueous composition, when the exothermic reaction in step (i) is finished, i.e., when the polymerization temperature in step (i) decreases. Preferably, the second mixture of ethylenically unsaturated monomers (ii) may be added to the aqueous composition, when the polymerization temperature in step (i) decreases by 3° C., preferably by 5° C.

The vinyl ester of an alkanoic acid (a) of the second mixture of ethylenically unsaturated monomers (ii) may have the structural formula of

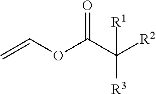

wherein R¹ is CH₃; and R² and R³ are alkyl groups which collectively contain 7 carbon atoms.

The vinyl ester of an alkanoic acid (a) of the second mixture of ethylenically unsaturated monomers (ii) may have the structural formula of

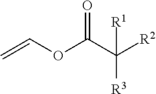

wherein R¹ is H; and R² and R³ are alkyl groups which collectively contain 6 carbon atoms, wherein preferably R² is an ethyl group and R³ is a butyl group. Suitable examples of a vinyl ester of an alkanoic acid (a) of the second mixture of ethylenically unsaturated monomers (ii) that can be used according to the present invention can be exemplified by VeoVa grade vinyl esters commercially available from Hexion Inc. (USA), such as VeoVa 9 vinyl ester, VeoVa 10 vinyl ester, and Veova EH vinyl ester.

According to the present invention, the second mixture of ethylenically unsaturated monomers (ii) may comprise at least 10 wt.-%, such as at least 13 wt.-%, or at least 15 wt.-%, or at least 18 wt.-%, or at least 20 wt.-%, or at least 23 wt.-%, or at least 25 wt.-% of the vinyl ester of an alkanoic acid (a). The second mixture of ethylenically unsaturated monomers (ii) may comprise 70 wt.-% or less, such as 65 wt.-% or less, or 60 wt.-% or less, or 55 wt.-% or less, or 50 wt.-% or less, or 45 wt.-% or less of the vinyl ester of an alkanoic acid (a). A person skilled in the art will appreciate that any range between any of the explicitly disclosed lower and upper limit is herein disclosed. Accordingly, the second mixture of ethylenically unsaturated monomers (ii) may comprise 10 to 70 wt.-%, preferably 15 to 60 wt.-%, more preferably 20 to 50 wt.-% of the vinyl ester of an alkanoic acid (a). The weight percentages are based on the total weight of the monomers in the second mixture of ethylenically unsaturated monomers.

The vinyl ester of an alkanoic acid (b) different than the vinyl ester of an alkanoic acid (a) in the second mixture of ethylenically unsaturated monomers (ii) may comprise vinyl acetate, 1-methylvinyl acetate, vinyl propionate, vinyl butyrate, vinyl laurate, vinyl pivalate, and combinations thereof. Preferably, the vinyl ester of an alkanoic acid (b) comprises vinyl acetate.

According to the present invention, the second mixture of ethylenically unsaturated monomers (ii) may comprise at least 30 wt.-%, such as at least 33 wt.-%, or at least 35 wt.-%, or at least 38 wt.-%, or at least 40 wt.-%, or at least 43 wt.-%, or at least 45 wt.-%, or at least 48 wt.-%, or at least 50 wt.-%, or at least 55 wt.-% of the vinyl ester of an alkanoic acid (b) different than the vinyl ester of an alkanoic acid (a). The second mixture of ethylenically unsaturated monomers (ii) may comprise 90 wt.-% or less, such as 88 wt.-% or less, or 85 wt.-% or less, or 83 wt.-% or less, or 80 wt.-% or less, or 78 wt.-% or less, or 75 wt.-% or less of the vinyl ester of an alkanoic acid (b) different than the vinyl ester of an alkanoic acid (a). A person skilled in the art will appreciate that any range between any of the explicitly disclosed lower and upper limit is herein disclosed. Accordingly, the second mixture of ethylenically unsaturated monomers (ii) may comprise 30 to 90 wt.-%, preferably 40 to 85 wt.-%, more preferably 50 to 80 wt.-% of the vinyl ester of an alkanoic acid (b) different than the vinyl ester of an alkanoic acid (a). The weight percentages being based on the total weight of the monomers in the second mixture of ethylenically unsaturated monomers.

According to the present invention, the second mixture of ethylenically unsaturated monomers (ii) may comprise 10 to 70 wt.-%, preferably 15 to 60 wt.-%, more preferably 20 to 50 wt.-% of the vinyl ester of an alkanoic acid (a); and 30 to 90 wt.-%, preferably 40 to 85 wt.-%, more preferably 50 to 80 wt.-% of the vinyl ester of an alkanoic acid (b) different than the vinyl ester of an alkanoic acid (a). The weight percentages being based on the total weight of the monomers in the second mixture of ethylenically unsaturated monomers.

The protective colloid of step (ii) may comprise polyvinyl alcohol, polyvinyl alcohol copolymers and combinations thereof as discussed above for the protective colloid of step (i). Preferably, the protective colloid may comprise polyvinyl alcohol. Preferably, the protective colloid is added to the aqueous composition in step (i).

The second mixture of ethylenically unsaturated monomers may be added in their entirety or continuously, preferably continuously in step (ii) of the method of the present invention. Typically, the polymerization in step (ii) is an exothermic reaction, i.e., the reaction releases heat. Preferably, the second mixture of ethylenically unsaturated monomers is added continuously so that the reaction temperature in step (ii) does not exceed 90° C. The second mixture of ethylenically unsaturated monomers may be added continuously so that the reaction temperature in step (ii) is in the range of from 65 to 90° C., preferably 70 to 90° C. In addition, the polymerization temperature may further be controlled to be in the range of from 65 to 90° C., preferably 70 to 90° C. by cooling the aqueous composition, e.g., with a water-cooled jacket. Typically, the second mixture of ethylenically unsaturated monomers may be added continuously in a range of from 2 to 8 hours, preferably from 2 to 6 hours. Continuous addition may be carried out with a dropping funnel, with a syringe pump, or peristaltic pump.

The third mixture of ethylenically unsaturated monomers (iii) comprises: (a) a vinyl ester of an alkanoic acid of the structural formula

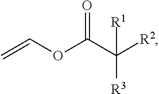

wherein R¹ is H or CH₃; and R² and R³ are alkyl groups which collectively contain 6 to 8 carbon atoms, preferably 6 or 7 carbon atoms; and (b) a (meth)acrylate.

During step (ii) of the method of the present invention, the ethylenically unsaturated monomers of the second monomer mixture can graft onto the protective colloids forming further seed particles. In addition, the ethylenically unsaturated monomers of the second monomer mixture can polymerize onto the seed particles and increase the particle size of the polymer particles.

The third mixture of ethylenically unsaturated monomers (iii) may be added to the aqueous composition, when no new seed particles are formed in step (ii). Typically, when no new seed particles are formed, the median particle size of the polymer particles increases, while the number of particles (Nₚ) in the aqueous composition decreases. The formation of new polymer (seed) particles may be monitored during the polymerization. Hereto, the median particle size of the obtained polymer dispersion may be determined by dynamic light scattering according to ISO 22412:2017, e.g., with the dynamic light scattering instrument Mastersizer 2000 (Malvern Panalytical (United Kingdom)). The number of particles (Nₚ) in the aqueous composition may be determined by dividing the total mass of polymerizable components that is added at any point in the process by the average particle volume, which in turn is calculated from the average particle size. The third mixture of ethylenically unsaturated monomers (iii) may be added to the aqueous composition, when the median particle size of the polymer dispersion in step (ii) increases, preferably by 5% to the median particle size of the seed particles formed in step (i). Typically, the formation of new seed particles is finished, when the protective colloids are fully incorporated

The vinyl ester of an alkanoic acid (a) of the third mixture of ethylenically unsaturated monomers (iii) may have the structural formula of

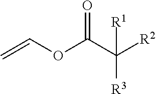

wherein R¹ is CH₃; and R² and R³ are alkyl groups which collectively contain 7 carbon atoms.

The vinyl ester of an alkanoic acid (a) of the third mixture of ethylenically unsaturated monomers (iii) may have the structural formula of

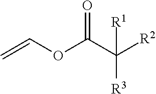

wherein R¹ is H; and R² and R³ are alkyl groups which collectively contain 6 carbon atoms, wherein preferably R² is an ethyl group and R³ is a butyl group.

Suitable examples of a vinyl ester of an alkanoic acid (a) of the third mixture of ethylenically unsaturated monomers (iii) that can be used according to the present invention can be exemplified by VeoVa grade vinyl esters commercially available from Hexion Inc. (USA), such as VeoVa 9 vinyl ester, VeoVa 10 vinyl ester, and Veova EH vinyl ester.

According to the present invention, the third mixture of ethylenically unsaturated monomers (iii) may comprise at least 10 wt.-%, such as at least 13 wt.-%, or at least 15 wt.-%, or at least 18 wt.-%, or at least 20 wt.-%, or at least 23 wt.-%, or at least 25 wt.-%, or at least 28 wt.-%, or at least 30 wt.-%, or at least 32 wt.-%, or at least 35 wt.-% of the vinyl ester of an alkanoic acid (a). The third mixture of ethylenically unsaturated monomers (iii) may comprise 70 wt.-% or less, such as 65 wt.-% or less, or 60 wt.-% or less, or 55 wt.-% or less, or 50 wt.-% or less, or 45 wt.-% or less of the vinyl ester of an alkanoic acid (a). A person skilled in the art will appreciate that any range between any of the explicitly disclosed lower and upper limit is herein disclosed. Accordingly, the third mixture of ethylenically unsaturated monomers (iii) may comprise 10 to 70 wt.-%, preferably 15 to 60 wt.-%, more preferably 30 to 50 wt.-% of the vinyl ester of an alkanoic acid (a). The weight percentages are based on the total weight of the monomers in the third mixture of ethylenically unsaturated monomers.

According to the present invention, the (meth)acrylate may be selected from methyl (meth)acrylate, ethyl (meth)acrylate, propyl (meth)acrylate, isopropyl (meth)acrylate, butyl (meth)acrylate, isobutyl (meth)acrylate, tert-butyl (meth)acrylate, hexyl (meth)acrylate, 2-ethylhexyl (meth)acrylate, heptyl (meth)acrylate, isooctyl (meth)acrylate, nonyl (meth)acrylate, 4-methyl-2-pentyl (meth)acrylate, 2-methylbutyl (meth)acrylate, 3,5,5-trimethylhexyl (meth)acrylate, and combinations thereof. Preferably, the (meth)acrylate may be selected from butyl (meth)acrylate and combinations thereof.

According to the present invention, the third mixture of ethylenically unsaturated monomers (iii) may comprise at least 30 wt.-%, such as at least 33 wt.-%, or at least 35 wt.-%, or at least 38 wt.-%, or at least 40 wt.-%, or at least 43 wt.-%, or at least 45 wt.-%, or at least 48 wt.-%, or at least 50 wt.-%, or at least 55 wt.-% of the (meth)acrylate. The third mixture of ethylenically unsaturated monomers (iii) may comprise 90 wt.-% or less, such as 88 wt.-% or less, or 85 wt.-% or less, or 83 wt.-% or less, or 80 wt.-% or less, or 78 wt.-% or less, or 75 wt.-% or less of the (meth)acrylate. A person skilled in the art will appreciate that any range between any of the explicitly disclosed lower and upper limit is herein disclosed. Accordingly, the third mixture of ethylenically unsaturated monomers (iii) may comprise 35 to 90 wt.-%, preferably 40 to 85 wt.-%, more preferably 50 to 80 wt.-% of the (meth)acrylate. The weight percentages being based on the total weight of the monomers in the third mixture of ethylenically unsaturated monomers.

According to the present invention, the third mixture of ethylenically unsaturated monomers (iii) may comprise 10 to 70 wt.-%, preferably 15 to 60 wt.-%, more preferably 30 to 50 wt.-% of the vinyl ester of an alkanoic acid (a); and 35 to 90 wt.-%, preferably 40 to 85 wt.-%, more preferably 50 to 80 wt.-% of the (meth)acrylate. The weight percentages being based on the total weight of the monomers in the third mixture of ethylenically unsaturated monomers.

The third mixture of ethylenically unsaturated monomers (iii) may not comprise any vinyl ester other than the vinyl ester of an alkanoic acid (a). The third mixture of ethylenically unsaturated monomers (iii) may be polymerized without the presence of dissolved protective colloids in the aqueous composition. As used herein, the term “without the presence of dissolved protective colloids” refers to amounts of the protective colloids of less than 0.05 wt.-%, preferably less than 0.01 wt.-%, the weight percentages being based on the total weight of the monomers in the first to fourth mixtures of ethylenically unsaturated monomers. In effect, this may be the stage at which no new particles are made.

The third mixture of ethylenically unsaturated monomers may be added in their entirety or continuously, preferably continuously, in step (iii) of the method of the present invention. Typically, the polymerization in step (iii) is an exothermic reaction, i.e., the reaction releases heat. Preferably, the third mixture of ethylenically unsaturated monomers is added continuously so that the reaction temperature in step (iii) does not exceed 90° C. The third mixture of ethylenically unsaturated monomers may be added continuously so that the reaction temperature in step (iii) is in the range of from 70 to 90° C. In addition, the polymerization temperature may further be controlled to be in the range of from 65 to 90° C., preferably 70 to 90° C. by cooling the aqueous composition, e.g., with a water-cooled jacket. Typically, the third mixture of ethylenically unsaturated monomers may be added continuously in a range of from 20 min to 8 hours, preferably from 20 min to 6 hours. Continuous addition may be carried out with a dropping funnel, with a syringe pump, or peristaltic pump.

According to the present invention, the fourth mixture of ethylenically unsaturated monomers (iv) comprises a vinyl ester of an alkanoic acid. The vinyl ester of an alkanoic acid of the fourth mixture of ethylenically unsaturated monomers (iv) may comprise vinyl acetate, 1-methylvinyl acetate, vinyl propionate, vinyl butyrate, vinyl laurate, vinyl pivalate, and combinations thereof. Preferably, the vinyl ester of an alkanoic acid of the fourth mixture of ethylenically unsaturated monomers (iv) may comprise vinyl acetate.

The fourth mixture of ethylenically unsaturated monomers (iv) may be added to the aqueous composition, when the exothermic reaction in step (iii) is finished, i.e., when the polymerization temperature in step (iii) decreases. Preferably, the second mixture of ethylenically unsaturated monomers (iii) may be added to the aqueous composition, when the polymerization temperature in step (i) decreases by 3° C., preferably by 5° C. Preferably, the fourth mixture of ethylenically unsaturated monomers (iv) may be added to the aqueous composition when the monomer conversion in step (iii) is in a range of from 94 to 99 wt.-%.

The fourth mixture of ethylenically unsaturated monomers may be added in their entirety or continuously, preferably continuously, in step (iv) of the method of the present invention. Typically, the polymerization in step (iv) is an exothermic reaction, i.e., the reaction releases heat. Preferably, the fourth mixture of ethylenically unsaturated monomers is added continuously so that the reaction temperature in step (iv) does not exceed 90° C. The fourth mixture of ethylenically unsaturated monomers may be added continuously so that the reaction temperature in step (iv) is in the range of from 65 to 90° C., preferably 70 to 90° C. In addition, the polymerization temperature may further be controlled to be in the range of from 65 to 90° C., preferably 70 to 90° C. by cooling the aqueous composition, e.g., with a water-cooled jacket. Typically, the fourth mixture of ethylenically unsaturated monomers may be added continuously in a range of from 2 to 8 hours, preferably from 2 to 6 hours. Continuous addition may be carried out with a dropping funnel, with a syringe pump, or peristaltic pump.

The first mixture of ethylenically unsaturated monomers (i) may comprise at least 0.5 wt.-%, such as at least 1.0 wt.-%, or at least 1.5 wt.-%, or at least 2.0 wt.-%, or at least 2.5 wt.-% of the ethylenically unsaturated monomers. The first mixture of ethylenically unsaturated monomers (i) may comprise 20 wt.-% or less, such as 15 wt.-% or less, or 15 wt.-% or less, or 13 wt.-% or less, or 10 wt.-% or less of the ethylenically unsaturated monomers. A person skilled in the art will appreciate that any range between any of the explicitly disclosed lower and upper limit is herein disclosed. Accordingly, the first mixture of ethylenically unsaturated monomers (i) may comprise 0.5 to 15 wt.-%, preferably 1 to 15 wt.-% of the ethylenically unsaturated monomers. The weight percentages being based on the total weight of the ethylenically unsaturated monomers of the first to fourth mixtures of ethylenically unsaturated monomers.

The second mixture of ethylenically unsaturated monomers (ii) may comprise at least 30 wt.-%, such as at least 35 wt.-%, or at least 45 wt.-%, or at least 50 wt.-%, or at least 55 wt.-%, or at least 60 wt.-%, or at least 65 wt.-% of the ethylenically unsaturated monomers. The second mixture of ethylenically unsaturated monomers (ii) may comprise 92 wt.-% or less, such as 90 wt.-% or less, or 88 wt.-% or less, or 85 wt.-% or less, or 82 wt.-% or less of the ethylenically unsaturated monomers. A person skilled in the art will appreciate that any range between any of the explicitly disclosed lower and upper limit is herein disclosed. Accordingly, the second mixture of ethylenically unsaturated monomers (ii) may comprise 35 to 92 wt.-%, preferably 35 to 90 wt.-% of the ethylenically unsaturated monomers. The weight percentages being based on the total weight of the ethylenically unsaturated monomers of the first to fourth mixtures of ethylenically unsaturated monomers.

The third mixture of ethylenically unsaturated monomers (iii) may comprise at least 5 wt.-%, such as at least 8 wt.-%, or at least 10 wt.-%, or at least 12 wt.-%, or at least 15 wt.-% of the ethylenically unsaturated monomers. The third mixture of ethylenically unsaturated monomers (iii) may comprise 50 wt.-% or less, such as 48 wt.-% or less, or 45 wt.-% or less, or 42 wt.-% or less, or 40 wt.-% or less of the ethylenically unsaturated monomers. A person skilled in the art will appreciate that any range between any of the explicitly disclosed lower and upper limit is herein disclosed. Accordingly, the third mixture of ethylenically unsaturated monomers (iii) may comprise 8 to 50 wt.-%, preferably 10 to 50 wt.-% of the ethylenically unsaturated monomers. The weight percentages being based on the total weight of the ethylenically unsaturated monomers of the first to fourth mixtures of ethylenically unsaturated monomers.

The fourth mixture of ethylenically unsaturated monomers (iv) may comprise at least 0.5 wt.-%, such as at least 1.0 wt.-%, or at least 1.5 wt.-%, or at least 2.0 wt.-%, or at least 2.5 wt.-% of the ethylenically unsaturated monomers. The fourth mixture of ethylenically unsaturated monomers (iv) may comprise 25 wt.-% or less, such as 20 wt.-% or less, or 15 wt.-% or less, or 10 wt.-% or less of the ethylenically unsaturated monomers. A person skilled in the art will appreciate that any range between any of the explicitly disclosed lower and upper limit is herein disclosed. Accordingly, the fourth mixture of ethylenically unsaturated monomers (iv) may comprise 0.5 to 20 wt.-%, preferably 1 to 20 wt.-% of the ethylenically unsaturated monomers. The weight percentages being based on the total weight of the ethylenically unsaturated monomers of the first to fourth mixtures of ethylenically unsaturated monomers.

According to the present invention, the first mixture of ethylenically unsaturated monomers (i) may comprise 1 to 15 wt.-% of the ethylenically unsaturated monomers; the second mixture of ethylenically unsaturated monomers (ii) may comprise 35 to 90 wt.-% of the ethylenically unsaturated monomers; the third mixture of ethylenically unsaturated monomers (iii) may comprise 8 to 50 wt.-% of the ethylenically unsaturated monomers; and the fourth mixture of ethylenically unsaturated monomers (iv) may comprise 1 to 20 wt.-% of the ethylenically unsaturated monomers. The weight percentages being based on the total weight of the ethylenically unsaturated monomers of the first to fourth mixtures of ethylenically unsaturated monomers.

The selection of the ethylenically unsaturated monomers and the proportion of the ethylenically unsaturated monomers of any of the first to fourth mixtures of ethylenically unsaturated monomers may be carried out in such a way that the polymer dispersion has a glass transition temperature (Tg) of 120° C. or less, preferably in a range of from −50° C. to 60° C., more preferably from −30 to 40° C., most preferably from −15° C. to 20° C. The glass transition temperatures can be determined by differential scanning calorimetry (DSC). The skilled person is aware in this context that DSC is only sufficiently conclusive if, after an initial heating cycle to a temperature that is at least 25° C. above the highest glass transition or melting temperature but at least 20° C. below the lowest decomposition temperature of a material, the material sample is kept at this temperature for at least 2 min. The sample is then cooled down to a temperature of at least 20° C. below the lowest glass transition or melting temperature to be determined, whereby the cooling rate should be a maximum of 20° C./min, preferably a maximum of 10° C./min. After a further waiting time of a few minutes, the actual measurement then takes place, during which the sample is heated to at least 20° C. above the highest melting or glass transition temperature at a heating rate of generally 10° C./min or less. The respective highest and lowest limit temperatures can be roughly specified in simple preliminary measurements with a separate sample.

Surprisingly, it has been found that the method for producing a polymer dispersion according to the present invention allows a homogeneous distribution of the monomers despite the different reactivity ratios of the vinyl ester of an alkanoic acid (a), the vinyl ester of an alkanoic acid (b) different than the vinyl ester of an alkanoic acid (a) and the (meth)acrylate. The mixtures of ethylenically unsaturated monomers are polymerized by free-radical emulsion or suspension polymerization. Preferably, the mixtures of ethylenically unsaturated monomers are polymerized by free-radical emulsion polymerization.

The method of the present invention for producing a polymer dispersion may be performed at temperatures of from 0 to 130° C., preferably of from 40 to 100° C., more preferably of from 60 to 90° C. The temperature includes all values and sub-values therebetween, especially including 5, 10, 15, 20, 25, 30, 35, 40, 45, 50, 55, 60, 65, 70, 75, 80, 85, 90, 95, 100, 105, 110, 115, 120 and 125° C.

The polymerization may be initiated using an initiator. Initiators which can be used when carrying out the present invention may include water-soluble and/or oil-soluble initiators which are effective for the purposes of the polymerization. Representative initiators are well known in the technical area and include, for example: azo compounds (such as, for example, AIBN, AMBN and cyanovaleric acid) and inorganic peroxy compounds, such as hydrogen peroxide, sodium, potassium and ammonium peroxydisulfate, peroxycarbonates and peroxyborates, as well as organic peroxy compounds, such as alkyl hydroperoxides, dialkyl peroxides, acyl hydroperoxides, and diacyl peroxides, as well as esters, such as tert-butyl perbenzoate and combinations of inorganic and organic initiators. Suitable initiators may be selected from 2,3-dimethyl-2,3-diphenylbutane, tert-butyl hydroperoxide, tert-amyl hydroperoxide, cumyl hydroperoxide, 1,1,3,3-tetramethylbutyl hydroperoxide, isopropylcumyl hydroperoxide, p-menthane hydroperoxide, 2,5-di(tert-butylperoxy)-2,5-dimethyl-3-hexyne, 3,6,9-triethyl-3,6,9-trimethyl-1,4,7-triperoxonane, di (tert-butyl) peroxide, 2,5-dimethyl-2,5-di(tert-butylperoxy) hexane, di (tert-butylperoxy-isopropyl)benzene, tert-butyl cumyl peroxide, di-(tert-amyl)-peroxide, dicumyl peroxide, butyl 4,4-di (tert-butylperoxy) valerate, tert-butylperoxybenzoate, 2,2-di (tert-butylperoxy) butane, tert-amyl peroxy-benzoate, tert-butylperoxy-acetate, tert-butylperoxy-(2-ethylhexyl) carbonate, tert-butylperoxy isopropyl carbonate, tert-butyl peroxy-3,5,5-trimethyl-hexanoate, 1,1-di (tert-butylperoxy)cyclohexane, tert-amyl peroxyacetate, tert-amylperoxy-(2-ethylhexyl) carbonate, 1,1-di (tert-butylperoxy)-3,5,5-trimethylcyclohexane, 1,1-di (tert-amylperoxy)cyclohexane, tert-butyl-monoperoxy-maleate, 1,1′-azodi(hexahydrobenzonitrile), tert-butyl peroxy-isobutyrate, tert-butyl peroxydiethylacetate, tert-butyl peroxy-2-ethylhexanoate, dibenzoyl peroxide, tert-amyl peroxy-2-ethylhexanoate, di (4-methylbenzoyl) peroxide, 1,1,3,3-tetramethylbutyl peroxy-2-ethylhexanoate, ammonium peroxodisulfate, 2,5-dimethyl-2,5-di (2-ethylhexanoylperoxy) hexane, 2,2′-azodi(2-methylbutyronitrile), 2,2′-azodi(isobutyronitrile), didecanoyl peroxide, potassium persulfate, dilauroyl peroxide, di (3,5,5-trimethylhexanoyl) peroxide, tert-amyl peroxypivalate, tert-butyl peroxyneoheptanoate, 1,1,3,3-tetramethylbutyl peroxypivalate, tert-butyl peroxypivalate, dicetyl peroxydicarbonate, dimyristyl peroxydicarbonate, di (2-ethylhexyl) peroxydicarbonate, di (4-tert-butylcyclohexyl) peroxydicarbonate, diisopropyl peroxydicarbonate, tert-butyl peroxyneodecanoate, di-sec-butyl peroxydicarbonate, tert-amyl peroxyneodecanoate, cumyl peroxyneoheptanoate, di (3-methoxybutyl) peroxydicarbonate, 1,1,3,3-tetramethylbutyl peroxyneodecanoate, cumyl peroxyneodecanoate, diisobutyryl peroxide, and mixture thereof.

The initiator may be used in a sufficient amount to initiate the polymerization reaction at a desired rate. In general, an amount of initiator of from 0.01 to 5 wt.-%, preferably of from 0.1 to 4 wt.-%, based on the total weight of monomers in the respective monomer mixture, is sufficient. The amount of initiator is most preferably of from 0.01 to 2 wt.-%, based on the total weight of monomers in the respective monomer mixture. The amount of initiator includes all values and sub-values therebetween, especially including 0.01, 0.1, 0.5, 1, 1.5, 2, 2.5, 3, 4 and 4.5 wt.-%, based on the total weight of monomers in the monomer mixture.

The above-mentioned inorganic and organic peroxy compounds may also be used alone or in combination with one or more suitable reducing agents, as is well known in the art. Examples of such reducing agents may include sulfur dioxide, alkali metal disulfites, alkali metal and ammonium hydrogen sulfites, thiosulfates, dithionites and formaldehyde sulfoxylates, as well as hydroxylamine hydrochloride, hydrazine sulfate, iron (II) sulfate, cuprous naphthanate, glucose, sulfonic acid compounds such as sodium methane sulfonate, amine compounds such as dimethylaniline and ascorbic acid. The quantity of the reducing agent is preferably 0.03 to 10 parts by weight per part by weight of the polymerization initiator.

The polymerization according to the present invention is preferably carried out without the addition of surfactants or emulsifiers. In exceptional cases, it can be advantageous to make addition use of small amounts of surfactants or emulsifiers, for example for 1 to 5 wt.-% based on the total weight of monomers in all of the monomer mixtures. Surfactants or emulsifiers which are suitable for stabilizing the dispersion polymer may include those conventional surface-active agents for polymerization processes. The surfactant or surfactants can be added to the aqueous phase and/or the monomer phase. Representative surfactants include saturated and ethylenically unsaturated sulfonic acids or salts thereof, including, for example, unsaturated hydrocarbonsulfonic acid, such as vinylsulfonic acid, allylsulfonic acid and methallylsulfonic acid, and salts thereof; aromatic hydrocarbon acids, such as, for example, p-styrenesulfonic acid, isopropenylbenzenesulfonic acid and vinyloxybenzenesulfonic acid and salts thereof; sulfoalkyl esters of acrylic acid and methacrylic acid, such as, for example, sulfoethyl methacrylate and sulfopropyl methacrylate and salts thereof, and 2-acrylamido-2-methylpropanesulfonic acid and salts thereof; alkylated diphenyl oxide disulfonates, sodium dodecylbenzenesulfonates and dihexyl or dioctyl esters of sodium sulfosuccinate, sodium alkyl esters of sulfonic acid, ethoxylated alkylphenols and ethoxylated alcohols; fatty alcohol sulfates and fatty alcohol (poly) ether sulfates.

After the polymerization in step (iv) is complete, an after-polymerization can be carried out by known methods to remove residual monomer, for example by means of after-polymerization initiated by a redox initiator. The redox initiator may be any of the above-mentioned inorganic and organic peroxy compounds in combination with one or more suitable reducing agents. Volatile residual monomers can also be removed by means of distillation, preferably under reduced pressure, and, if desired, with inert stripping gases such as air, nitrogen or steam being passed through or over the dispersion.

The present invention relates to an aqueous polymer dispersion obtained by the method of the present invention as discussed above. The aqueous polymer dispersion of the present invention may have a solids content of from 30 to 75 wt.-%, preferably from 40 to 70 wt.-%, more preferably from 50 to 65 wt.-%.

The polymer dispersion may have a glass transition temperature (Tg) of 120° C. or less, preferably in a range of from −50° C. to 60° C., more preferably from −30 to 40° C., most preferably from −15° C. to 20° C. The glass transition temperatures can be determined by differential scanning calorimetry (DSC) as described above.

Moreover, the present invention further relates to a redispersible polymer powder obtained by drying the aqueous polymer dispersion of the present invention. The drying may be achieved by fluidized-bed drying, freeze drying or spray drying. Preferably, the drying is achieved by spray drying. Spray drying may be carried out in customary spray dryers, and atomization may be achieved by means of single-fluid, two-fluid or multifluid nozzles or by means of a rotary disk. The outlet temperature is generally set in the range of from 45° C. to 120° C., preferably from 60° C. to 90° C. The aqueous polymer dispersion may be dried by spay drying after addition of a spraying aid, such as protective colloids.

Suitable spraying aids are polyvinyl alcohols; polyvinylpyrrolidones; polysaccharides in water-soluble form, i.e. starches such as amylose and amylopectin, celluloses and their carboxymethyl, methyl, hydroxyethyl and hydroxypropyl derivatives; proteins such as casein or caseinate, soya protein, gelatin; lignosulfonates; synthetic polymers such as poly(meth)acrylic acid, copolymers of (meth)acrylates with carboxyl-functional comonomer units, poly(meth)acrylamide, polyvinylsulfonic acids and their water-soluble copolymers; melamine-formaldehyde sulfonates, naphthalene-formaldehyde sulfonates, styrene-maleic acid and vinyl ether-maleic acid copolymers, preferably polyvinyl alcohols. If added, the spraying aids may be added to the aqueous polymer dispersion of the present invention in an amount of from 3 to 30 wt.-%, such as 5 to 20 wt.-%, based on the total weight of the solids content of the aqueous polymer dispersion.

The viscosity of the aqueous polymer dispersion of the present invention to be dried by spray-drying may have a viscosity at 23° C. of less than 500 mPa·s, preferably of less than 350 mPa·s, more preferably of less than 250 mPa·s. The viscosity can be measured according to ASTM D-3236 using a Brookfield Model DV-II+ viscometer (commercially available from Brookfield Engineering Laboratories, Inc. (USA)) and spindle 0 or 1 at 23° C.

The present invention further relates to use of the aqueous polymer dispersion of the present invention or the redispersible polymer powder of the present invention in building materials, such as building adhesives, plasters, fillers, floor fillers, sealing slurries, grouts and paints.

Furthermore, the present invention relates to a building material comprising the aqueous polymer dispersion of the present invention or the redispersible polymer powder of the present invention. According to the present invention, the building material may be selected from cementitious tile adhesives; self-leveling substrates; thermal insulation systems (ETICS); repair mortars; cementitious grouts; joint fillers; plaster and gypsum; jointing compounds; fillers; or waterproofing compounds.

The present invention will be further illustrated with reference to the following examples.

### Examples

In the following all parts and percentages are based on weight unless otherwise specified.

### Preparation of the Polymer Dispersion Via Multi-Step Polymerization

The polymer dispersion was prepared by free radical emulsion polymerization carried out in a sealed water/oil jacketed glass vessel, with a water-cooled condenser and with agitation. The quantities used for the multi-step polymerization of the present invention are listed in Table 1.

TABLE 1
Example 1

| Example | 1 |
|---|---|
| Components | Parts per 100 monomers |

Step (i)

| | |
|---|---|
| Polyvinyl alcohol¹ | 5 |
| Vinyl acetate | 6 |
| Veova 10 vinyl ester² | 4 |
| n-dodecyl mercaptan | 0.2 |
| Sodium bicarbonate | 0.1 |
| Potassium persulfate | 0.1 |

Step (ii)

| | |
|---|---|
| Vinyl acetate | 49 |
| Veova 10 vinyl ester² | 16 |
| Potassium persulfate | 0.1 |

Step (iii)

| | |
|---|---|
| Butyl acrylate | 15 |
| Veova 10 vinyl ester² | 5 |
| Potassium persulfate | 0.02 |

Step (iv)

| | |
|---|---|
| Vinyl acetate | 5 |
| Potassium persulfate | 0.01 |

¹Mowiol ® 4-88 (commercially available from Clariant GmbH (Germany))
²Commercially available from Hexion Inc. (USA)

pphm (parts by wight based on 100 parts of total monomer weight) of polyvinyl alcohol was dissolved at 10% wt/wt of water at a temperature of 75° C. A monomer mixture (step (i)) of Vinyl acetate and VeoVa 10 vinyl ester was added to the aqueous composition. Thereafter, n-dodecyl mercaptan and sodium bicarbonate were added to the aqueous mixture. The polymerization reaction was initiated by adding a 5% (w/w) potassium persulfate aqueous solution. The reaction mixture heated up to a temperature of 75-85° C. Seed particles having a median particle size of 100-300 nm were obtained as determined by dynamic light scattering according to ISO 22412:2017 with the dynamic light scattering instrument Mastersizer 2000 (Malvern Panalytical (UK)). When the reaction temperature was stable, i.e., no longer increasing, a monomer mixture (step (ii)) of vinyl acetate and VeoVa 10 vinyl ester and in parallel a 5% (w/w) potassium persulfate aqueous solution were continuously added to the reaction. The rate of addition was controlled to maintain a temperature in a range of from 70 to 90° C. After finishing the addition (step (ii)), the polymerization was continued and the median particle size of the formed particles of the aqueous reaction mixture was recorded by measuring with dynamic light scattering according to ISO 22412:2017 with the dynamic light scattering instrument Mastersizer 2000 (Malvern Panalytical (UK)). A monomer mixture (step (iii)) of VeoVa 10 vinyl ester and butyl acrylate was continuously added to the aqueous reaction mixture, when no new polymer particles were formed and the median particle size of the formed particles increased by 5% compared to the seed particles formed during the polymerization. Parallelly, a 5% (w/w) potassium persulfate aqueous solution was added continuously to the reaction. The rate of addition was controlled to maintain a temperature in a range of from 70 to 90° C. After finishing the addition, the polymerization was continued. When the reaction temperature was stable, i.e., no longer increasing, vinyl acetate and a 5% (w/w) potassium persulfate aqueous solution was added to the reaction mixture continuously. The reaction mixture was polymerized until a residual monomer level of less than 1000 ppm was reached. The residual monomer level was determined by gas chromatography. The polymer dispersion had a solids content of 50% and a median particle size of 500-5000 nm. The median particle size was determined by dynamic light scattering according to ISO 22412:2017 with the dynamic light scattering instrument Mastersizer 2000 (Malvern Panalytical (UK)).

### Preparation of the Polymer Dispersion Via Standard Polymerization

The polymer dispersion was prepared by free radical emulsion polymerization carried out in a sealed water/oil jacketed glass vessel, with a water-cooled condenser and with agitation. The quantities used for the standard polymerization are listed in Table 2.

TABLE 2
Example 2

| Example | 2 |
|---|---|
| Components | Parts per 100 monomers |
| Polyvinyl alcohol¹ | 5 |
| Vinyl acetate | 60 |
| Veova 10 vinyl ester² | 25 |
| Butyl acrylate | 15 |
| n-dodecyl mercaptan | 0.2 |
| Sodium bicarbonate | 0.1 |
| Potassium persulfate | 0.2 |

¹Mowiol ® 4-88 (commercially available from Clariant GmbH (Germany))
²Commercially available from Hexion Inc. (USA)

5 pphm (parts by wight based on 100 parts of total monomer weight) of polyvinyl alcohol was dissolved at 10% wt/wt of water at a temperature of 75° C. A monomer mixture of 7.5 pphm of vinyl acetate and 2.5 pphm of VeoVa 10 vinyl ester were added to the aqueous composition. Thereafter, n-dodecyl mercaptan and sodium bicarbonate were added to the aqueous mixture. The polymerization reaction was initiated by adding a 5% (w/w) potassium persulfate solution (0.1 pphm). The reaction mixture heated up to a temperature of 75-85° C. Seed particles having a median particle size of 100-300 nm were obtained as determined by dynamic light scattering according to ISO 22412:2017 with the dynamic light scattering instrument Mastersizer 2000 (Malvern Panalytical (UK)). After 0.5 hours a monomer mixture of 52.5 pphm of vinyl acetate, 22.5 pphm of VeoVa 10 vinyl ester, and 15 pphm of butyl acrylate was continuously added to the aqueous reaction mixture. Parallelly, a 5% (w/w) potassium persulfate aqueous solution (0.1 pphm) was added continuously to the reaction. The rate of addition was controlled to maintain a temperature in a range of from 70 to 90° C. The polymerization was continued until no more heat of polymerization was observed. The polymer dispersion had a solids content of 50% and a median particle size of 500-5000 nm. The median particle size was determined by dynamic light scattering according to ISO 22412:2017 with the dynamic light scattering instrument Mastersizer 2000 (Malvern Panalytical (UK)).

Further polymer dispersions via standard polymerization were prepared using the quantities as listed in Tables 3 and Table 4.

TABLE 3
Example 3

| Example | 3 |
|---|---|
| Components | Parts per 100 monomers |
| Polyvinyl alcohol¹ | 5 |
| Vinyl acetate | 70 |
| Veova 10 vinyl ester² | 30 |
| n-dodecyl mercaptan | 0.2 |
| Sodium bicarbonate | 0.1 |
| Potassium persulfate | 0.2 |

¹Mowiol ® 4-88 (commercially available from Clariant GmbH (Germany))
²Commercially available from Hexion Inc. (USA)

5 pphm (parts by wight based on 100 parts of total monomer weight) of polyvinyl alcohol was dissolved at 10% wt/wt of water at a temperature of 75° C. 7 pphm of vinyl acetate and 3 pphm of VeoVa 10 vinyl ester were added to the aqueous composition. Thereafter, n-dodecyl mercaptan and sodium bicarbonate were added to the aqueous mixture. The polymerization reaction was initiated by adding a 5% (w/w) potassium persulfate aqueous solution (0.1 pphm). The reaction mixture heated up to a temperature of 75-85° C. Seed particles having a median particle size of 100-300 nm were obtained as determined by dynamic light scattering according to ISO 22412:2017 with the dynamic light scattering instrument Mastersizer 2000 (Malvern Panalytical (UK)). After 0.5 hours, a monomer mixture of 63 pphm of vinyl acetate, and 27 pphm of VeoVa 10 vinyl ester was continuously added to the aqueous reaction mixture. Parallelly, a 5% (w/w) potassium persulfate solution (0.1 pphm) was added continuously to the reaction. The rate of addition was controlled to maintain a temperature in a range of from 70 to 90° C. The polymerization was continued until no more heat of polymerization was observed. The polymer dispersion had a solids content of 50% and a median particle size of 500-5000 nm. The median particle size was determined by dynamic light scattering according to ISO 22412:2017 with the dynamic light scattering instrument Mastersizer 2000 (Malvern Panalytical (UK)).

TABLE 4
Example 4

| Example | 4 |
|---|---|
| Components | Parts per 100 monomers |
| Polyvinyl alcohol¹ | 5 |
| Vinyl acetate | 80 |
| Veova 10 vinyl ester² | 20 |
| n-dodecyl mercaptan | 0.2 |
| Sodium bicarbonate | 0.1 |
| Potassium persulfate | 0.2 |

¹Mowiol ® 4-88 (commercially available from Clariant GmbH (Germany))
²Commercially available from Hexion Inc. (USA)

The same procedure as described for Example 4 was applied, with the exception that after the formation of the seed particles, a monomer mixture of 73 pphm of vinyl acetate, and 17 pphm of VeoVa 10 vinyl ester was continuously added to the aqueous reaction mixture. The polymer dispersion had a solids content of 50% and a median particle size of 500-5000 nm. The median particle size was determined by dynamic light scattering according to ISO 22412:2017 with the dynamic light scattering instrument Mastersizer 2000 (Malvern Panalytical (UK)).

### Production of Redispersible Polymer Powder

A 10% formulation was made i.e., by wt (10 g) of the polymer dispersions of Examples 1 to 4 were admixed with 1 g g of Mowiol® 4-88 (commercially available from Clariant GmbH (Germany)) and diluted with water to a diluted viscosity of 250 mPa·s at 23° C. The viscosity was measured according to ASTM D-3236 using a Brookfield Model DV-II+viscometer (commercially available from Brookfield Engineering Laboratories, Inc. (USA)) and spindle 0-1 at 23° C. The dispersions were then spray dried by means of a two-fluid nozzle rotary disc atomizer. Atomization was performed with air compressed to 4.105 Pa, and the droplets formed were dried in cocurrent air heated to 125° C.

### Determination of Wet Adhesion

To determine the wet adhesion of the polymer dispersions, a tile adhesive mortar mixture was prepared according to the formulation of Table 5.

TABLE 5
Tile adhesive mortar

| Component | Wt.-% |
|---|---|
| CEM I 52.5 R Mielke ® premium¹ | 35.00 |
| Quartz Sand H33 (100-500 μm)² | 59.10 |
| Calcium formate | 0.50 |
| Culminal ™ C9168³ | 0.40 |
| Redispersible polymer powder | 5.00 |

¹Commercially available from HeidelbergCement AG (Germany))
²Commercially available from Quarzwerke GmbH (Germany)
³Commercially available from Ashland Inc. (USA)

The redispersible polymer powder of Example 1 to 4 were used as well as VINNAPAS® 7220E (commercially available from Wacker Chemie AG (Germany)) to prepare a cement mixture. VINNAPAS® eco 7220E is based on a copolymer of vinylacetate, ethylene and methyl methacrylate.

The tile adhesive mortar was mixed with 24 g water per 100 g dry mortar. The adhesive strength was determined after water storage according to DIN EN 1348:2007 (item 8.3) and the determined adhesive strengths of the respective examples were normalized to the adhesive strength of Example 3. The results are listed in Table 6.

TABLE 6
Normalized adhesive strengths

| Redispersible polymer powder | Adhesive strength [%] |
|---|---|
| Example 1 | 120 |
| Example 2 | 80 |
| Example 3 | 100 |
| Example 4 | 95 |
| VINNAPAS ® 7220E | 120 |

It is visible in Table 6 that Example 1, which is prepared by the multi-step polymerization, provides improved wet adhesion compared to Examples 2 to 4, which are prepared by the standard polymerization. Example 2, which is prepared by the standard polymerization, provides an uneven blocky distribution of Veova 10 vinyl ester in the vinyl acetate/Veova 10 vinyl ester/butyl acrylate copolymer, which results in poor chemical resistance and impaired wet adhesion.

1. A method for producing a polymer dispersion by free-radical emulsion or suspension polymerization of a mixture of ethylenically unsaturated monomers comprising the steps of:
(i) providing an aqueous composition comprising a first mixture of ethylenically unsaturated monomers comprising:
(a) a vinyl ester of an alkanoic acid of the structural formula 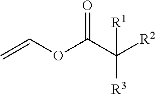
wherein R¹ is H or CH₃; and R² and R³ are alkyl groups which collectively contain 6 to 8 carbon atoms; and
(b) a vinyl ester of an alkanoic acid different than the vinyl ester of an alkanoic acid (a);
and polymerizing the mixture of ethylenically unsaturated monomers in the presence of protective colloids to obtain seed particles;
(ii) adding a second mixture of ethylenically unsaturated monomers comprising:
(a) a vinyl ester of an alkanoic acid of the structural formula 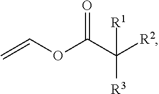
wherein R¹ is H or CH₃; and R² and R³ are alkyl groups which collectively contain 6 to 8 carbon atoms; and
(b) a vinyl ester of an alkanoic acid different than the vinyl ester of an alkanoic acid (a);
to the aqueous composition after step (i);
and polymerizing the mixture of ethylenically unsaturated monomers in the presence of protective colloids;
(iii) adding a third mixture of ethylenically unsaturated monomers comprising:
(a) a vinyl ester of an alkanoic acid of the structural formula 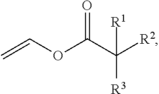
wherein R¹ is H or CH₃; and R² and R³ are alkyl groups which collectively contain 6 to 8 carbon atoms; and
(b) a (meth)acrylate;
to the aqueous composition after step (ii);
and polymerizing the mixture of ethylenically unsaturated monomers;
(iv) adding a fourth mixture of ethylenically unsaturated monomers comprising a vinyl ester of an alkanoic acid to the aqueous composition after step (iii); and polymerizing the mixture of ethylenically unsaturated monomers.

2. The method according to claim 1, wherein the vinyl ester of an alkanoic acid (a) in one of, more than one of, or all of the first to third mixture of ethylenically unsaturated monomers has the structural formula of 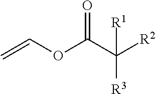
wherein R¹ is H or CH₃; and R² and R³ are alkyl groups which collectively contain 6 or 7 carbon atoms.

3. The method according to claim 1, wherein the vinyl ester of an alkanoic acid (a) in one of, more than one of, or all of the first to third mixture of ethylenically unsaturated monomers has the structural formula of 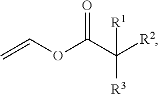
wherein R¹ is CH₃; and R² and R³ are alkyl groups which collectively contain 7 carbon atoms; and or
wherein the vinyl ester of an alkanoic acid (a) in one of, more than one of, or all of the first to third mixture of ethylenically unsaturated monomers has the structural formula of 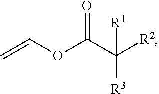
wherein R¹ is H; and R² and R³ are alkyl groups which collectively contain 6 carbon atoms.

4. The method according to claim 1, wherein the vinyl ester of an alkanoic acid (b) different than the vinyl ester of an alkanoic acid (a) in one of, more than one of, or all of the first to third mixture of ethylenically unsaturated monomers comprises vinyl acetate, 1-methylvinyl acetate, vinyl propionate, vinyl butyrate, vinyl laurate, vinyl pivalate, and combinations thereof; and/or
wherein the vinyl ester of an alkanoic acid of the fourth mixture of ethylenically unsaturated monomers comprises vinyl acetate, 1-methylvinyl acetate, vinyl propionate, vinyl butyrate, vinyl laurate, vinyl pivalate, and combinations thereof.

5. The method according to claim 1, wherein the first mixture of ethylenically unsaturated monomers comprises:
(a) 10 to 90 wt.-% of the vinyl ester of an alkanoic acid; and
(b) 10 to 90 wt.-% of the vinyl ester of an alkanoic acid different than the vinyl ester of an alkanoic acid (a);
the weight percentages being based on the total weight of the monomers in the first mixture of ethylenically unsaturated monomers; and/or
wherein the second mixture of ethylenically unsaturated monomers comprises:
(a) 10 to 70 wt.-% of the vinyl ester of an alkanoic acid; and
(b) 30 to 90 wt.-% of the vinyl ester of an alkanoic acid different than the vinyl ester of an alkanoic acid (a); and the weight percentages being based on the total weight of the monomers in the second mixture of ethylenically unsaturated monomers.

6. The method according to claim 1, wherein the third mixture of ethylenically unsaturated monomers comprises:
(a) 10 to 70 wt.-% of the vinyl ester of an alkanoic acid; and
(b) 35 to 90 wt.-% of the (meth)acrylate;
the weight percentages being based on the total weight of the monomers in the third mixture of ethylenically unsaturated monomers; and/or
wherein the (meth)acrylate is selected from methyl (meth)acrylate, ethyl (meth)acrylate, propyl (meth)acrylate, isopropyl (meth)acrylate, butyl (meth)acrylate, isobutyl (meth)acrylate, tert-butyl (meth)acrylate, hexyl (meth)acrylate, 2-ethylhexyl (meth)acrylate, heptyl (meth)acrylate, isooctyl (meth)acrylate, nonyl (meth)acrylate, 4-methyl-2-pentyl (meth)acrylate, 2-methylbutyl (meth)acrylate, 3,5,5-trimethylhexyl (meth)acrylate, and combinations thereof.

7. The method according to claim 1, wherein the seed particles in step (i) have a median particle size in the range of 100 to 300 nm.

8. The method according to claim 1, wherein the protective colloid of the first step (i) and/or second step (ii), and second step (ii) comprises polyvinyl alcohol, polyvinyl alcohol copolymers and combinations thereof; and/or
wherein the protective colloid is added in the first step (i) in an amount in a range of 2.0 to 11.0 wt.-%, the weight percentages being based on the total weight of the monomers in the first to fourth mixtures of ethylenically unsaturated monomers.

9. The method according to claim 8, wherein the polyvinyl alcohol has a degree of hydrolysis in a range of from 80 to 99 mol.-%; and
a viscosity in a range of from 1 to 56 mPa×s as determined by a Höppler falling ball viscometer following DIN 53015:2019 for a 4 wt.-% aqueous solution of the polyvinyl alcohol at 20° C.

10. The method according to claim 1, wherein the first mixture of ethylenically unsaturated monomers further comprises a chain transfer agent.

11. The method according to claim 1, wherein in step (ii) the second mixture of ethylenically unsaturated monomers is added continuously so that the reaction temperature is in the range of from 70 to 90° C.; and/or
wherein step (iii) is started when no new seed particles are formed in step (ii).

12. The method according to claim 1,
wherein in step (iii) the third mixture of ethylenically unsaturated monomers is added continuously so that the reaction temperature is in the range of from 70 to 90° C.; and/or
wherein the mixture of ethylenically unsaturated monomers is polymerized by free-radical emulsion polymerization.

13. The method according to claim 1, wherein
(i) the first mixture of ethylenically unsaturated monomers comprises 1 to 15 wt.-% of the ethylenically unsaturated monomers;
(ii) the second mixture of ethylenically unsaturated monomers comprises 35 to 90 wt.-% of the ethylenically unsaturated monomers;
(iii) the third mixture of ethylenically unsaturated monomers comprises 8 to 50 wt.-% of the ethylenically unsaturated monomers; and
(iv) the fourth mixture of ethylenically unsaturated monomers comprises 1 to 20 wt.-% of the ethylenically unsaturated monomers;
the weight percentages being based on the total weight of the ethylenically unsaturated monomers of the first to fourth mixtures of ethylenically unsaturated monomers.

14. An aqueous polymer dispersion obtained by the method according to claim 1.

15. A redispersible polymer powder obtained by drying the aqueous polymer dispersion according to claim 14.

16. Use of the aqueous polymer dispersion according to claim 14 in building materials.

17. A building material comprising the aqueous polymer dispersion according to claim 14.
